(19) United States
(12) Patent Application Publication
(10) Pub. No.: US 2015/0023123 A1
(43) Pub. Date: Jan. 22, 2015

(54) Apparatus and Method for Mixing Materials

(71) Applicants: Bobby Biorac, Warren, MI (US); Louis Adzic, Scottsdale, AZ (US)

(72) Inventors: Bobby Biorac, Warren, MI (US); Louis Adzic, Scottsdale, AZ (US)

(21) Appl. No.: 13/944,855

(22) Filed: Jul. 17, 2013

(51) Int. Cl. B28C 5/08

(52) U.S. Cl. CPC B28C 5/0856; B28C 5/0893
USPC 366/48

(57) ABSTRACT

A portable mixing apparatus is adapted for mixing materials in a wheelbarrow or other container and is removably attached to a mixer support stand using at least one pivot point. The portable mixer includes a drive mechanism and a mixing body where the mixing body is repositionable in three dimensions, allowing for maximum flexibility in positioning the mixing body within the interior space of the wheelbarrow. Once the mixing body has been positioned, the mixing body is rotated by means of the drive mechanism, which is affixed to the mixing body. The mixing body includes a plurality of mixing blades or paddles that will extend below the upper edge of the wheelbarrow frame and engage the materials to be mixed contained within the interior space of the wheelbarrow. The drive mechanism may be a hand crank or motor driven mechanism. A removable liner is also included in certain embodiments.

### BACKGROUND OF THE INVENTION

1. Technical Field

The present invention generally relates to mixing equipment and relates more specifically to the use of a wheelbarrow or similar container and a mechanical device for mixing various materials and compounds.

2. Background Art

Wheelbarrows are well known implements used to transport materials from one location to another. For example, at small and medium-sized construction sites it is frequently desirable to mix and transport relatively small amounts of concrete, mortar, gypsum and the like by mixing the granular base materials (e.g., cement, sand, or aggregate) with water. The resulting mixture must then be transported to the point of actual use and a wheelbarrow is a relatively inexpensive, convenient, and effective tool for this purpose. In other applications, such as feeding livestock, a feed or grain mixture may need to be mixed at one location and then transported to another location for consumption by the livestock.

In other instances, the mixing operation is completed on the ground or in a tub or similar container by placing the granular materials in a pile and pouring water or other liquid over the materials while manually mixing the materials with a shovel, hoe, or a similar implement. The final product (“slurry”) can then be shoveled into a wheelbarrow and transported to the desired destination. In other situations, the component materials may be mixed directly in a wheelbarrow to avoid shoveling the slurry into the wheelbarrow after the slurry components are mixed together.

Although adequate mixing can be accomplished with these prior art methods, the task is relatively tedious and far from exact. The presently employed methods largely require that the slurry be loaded from one container (or from the ground) into a wheelbarrow or the like which increases the labor and the time required to prepare the material. This means the mixing process can be time-consuming and will generally make the preparation of slurry more costly. Even in instances in which a separate mixing apparatus (e.g., concrete mixer) is provided, the mixing apparatus in itself represents a significant investment and is, therefore, costly. Moreover, extra equipment can clutter up the construction site and often cannot be readily moved about the site to position it closest to the point of use for the slurry or other finished product. Thus, even separate mixing equipment can be relatively inefficient and somewhat costly to operate.

Previous attempt have been made to simplify the mixing and transportation of small to modest quantities of concrete and other slurries. For example, U.S. Pat. No. 2,744,735 discloses a combined wheelbarrow-concrete mixer in which the mixer and the drive motor are mounted to the frame of the wheelbarrow beneath a container for the concrete and the base materials to be combined. Although this device eliminates the requirement of transferring the base materials and/or the mixed slurry from one container to another, this wheelbarrow is relatively heavy and therefore difficult to handle. Moreover, each wheelbarrow is furnished with a drive mechanism, making it a relatively expensive device. The cost of the device, coupled with the cumbersome handling of a wheelbarrow mounted with a motorized mixer significantly detracts from the utility of the wheelbarrow. These limitations have hindered adoption.

U.S. Pat. No. 3,820,763 seeks to overcome some of the shortcomings of the above-referenced patent by mounting the concrete mixing unit to a retractable overhead arm that can be permanently mounted to a suitable support surface such as the ground. In this instance, an overhead arm with a rotatable mixing blade is lowered into the container for mixing the concrete. This approach eliminates the bulk and weight of a motor being mounted to the wheelbarrow. However, it requires upright mounting posts that permit vertical travel of the overhead arm to clear the wheelbarrow, multiple joints, linear slide ways, etc., all of which greatly increases the cost and complexity of the device, once again limiting adoption.

Electric drum mixers have also been created to mix relatively small quantities or batches of materials. However, the electric drum mixer requires electricity to operate and is only capable of mixing one or two bags of cement at a time. This type of mixer can be quite heavy and usually requires a vehicle to transport it to the job site. Additionally, it is easy to overload the mixing drum and burn out the motor or trip a circuit breaker for the electrical supply circuit, making the electric mixer inoperable.

Similarly, truck mounted commercial mixing units are also widely used in the construction industry. These are typically gasoline powered units that are useful for mixing large quantities but less efficient for smaller batches and are relatively difficult to re-position at the job site, making them less convenient for many applications. Further, the expense of purchasing and maintaining these larger units make them less accessible for many contractors.

While many other devices for mixing small quantities or batches of cement and other slurries in a wheelbarrow exist, none have found wide commercial acceptance due to the issues described above. There remains a need for lightweight, inexpensive and portable apparatus that can simplify the process of mixing materials in a wheelbarrow as well as facilitate the delivery of the mixed material to its point of use. Accordingly, without improvements in the implements and methods used for mixing materials in a wheelbarrow, the process and results obtained by people employing these devices will continue to be sub-optimal.

### BRIEF SUMMARY OF THE INVENTION

A portable mixing apparatus is adapted for mixing materials in a wheelbarrow or other container and is removably attached to a mixer support stand using at least one pivot point. The portable mixer includes a drive mechanism and a mixing body where the mixing body is repositionable in three dimensions, allowing for maximum flexibility in positioning the mixing body within the interior space of the wheelbarrow. Once the mixing body has been positioned, the mixing body is rotated by means of the drive mechanism, which is affixed to the mixing body. The mixing body includes a plurality of mixing blades or paddles that will extend below the upper edge of the wheelbarrow frame and engage the materials to be mixed contained within the wheelbarrow. The drive mechanism may be a hand crank or motor. A removable liner is also included in certain embodiments.

With the robust and relatively simple design of the present invention, small batches of concrete and mortar are mixed directly in the wheelbarrow at the most convenient location.

### BRIEF DESCRIPTION OF THE FIGURES

The preferred embodiments of the present invention will hereinafter be described in conjunction with the appended drawings, wherein like designations denote like elements, and:

FIG. 1 is a perspective view of an apparatus for mixing materials in accordance with a preferred exemplary embodiment of the present invention;

FIG. 2 is a perspective view of a support stand for an apparatus for mixing materials in accordance with a preferred exemplary embodiment of the present invention;

FIG. 3 is a perspective view of an apparatus for mixing materials mounted in a substantially vertical position on the support stand of FIG. 2 in accordance with a preferred exemplary embodiment of the present invention;

FIG. 4 is a perspective view of an apparatus for mixing materials mounted in a substantially horizontal position on the support stand of FIG. 2 in accordance with a preferred exemplary embodiment of the present invention;

FIG. 5 is a perspective view of an apparatus for mixing materials in accordance with a preferred exemplary embodiment of the present invention mounted in a wheelbarrow;

FIG. 6 is a perspective view of a positioning mechanism for an apparatus for mixing materials to a wheelbarrow in accordance with a preferred exemplary embodiment of the present invention;

FIG. 7 is a perspective view of a pair of locking mechanisms for an apparatus for mixing materials in accordance with a preferred exemplary embodiment of the present invention in an unlocked position;

FIG. 8 is a perspective view of a pair of locking mechanisms for an apparatus for mixing materials in accordance with a preferred exemplary embodiment of the present invention in a locked position;

FIG. 9 is a perspective view of a pair of locking mechanisms for an apparatus for mixing materials in accordance with an alternative preferred exemplary embodiment of the present invention in an unlocked position;

FIG. 10 is a perspective view of a pair of locking mechanisms for an apparatus for mixing materials in accordance with an alternative preferred exemplary embodiment of the present invention in a locked position;

FIG. 11 is a perspective view of a plurality of mixing arms for an apparatus for mixing materials in accordance with a preferred exemplary embodiment of the present invention;

FIG. 12 is a perspective view of a plurality of mixing arms for an apparatus for mixing materials in accordance with a preferred exemplary embodiment of the present invention;

FIG. 13 is a perspective view of an apparatus for mixing materials in accordance with a preferred exemplary embodiment of the present invention;

FIG. 14 is a perspective view of an apparatus for mixing materials in accordance with a preferred exemplary embodiment of the present invention;

FIG. 15 is a perspective view of an apparatus for mixing materials in accordance with a preferred exemplary embodiment of the present invention;

FIG. 16 is a perspective view of an apparatus for mixing materials in accordance with a preferred exemplary embodiment of the present invention;

FIG. 17 is a perspective view of an apparatus for mixing materials in accordance with a preferred exemplary embodiment of the present invention;

FIG. 18 is a perspective view of an apparatus for mixing materials in accordance with a preferred exemplary embodiment of the present invention;

FIG. 19 is a perspective view of an apparatus for mixing materials in accordance with a preferred exemplary embodiment of the present invention;

FIG. 20 is a perspective view of an apparatus for mixing materials in accordance with a preferred exemplary embodiment of the present invention;

FIG. 21 is a perspective view of an apparatus for mixing materials in accordance with a preferred exemplary embodiment of the present invention;

FIG. 22 is a perspective view of an apparatus for mixing materials in accordance with a preferred exemplary embodiment of the present invention;

FIG. 23 is a flow chart of a method for mixing materials using a mixing apparatus in accordance with a preferred exemplary embodiment of the present invention;

FIG. 24 is a schematic drawing with a linear representation for the orientation of the planar angles of the various structures and surfaces involved with a mixing apparatus in accordance with a preferred exemplary embodiment of the present invention;

FIG. 25 is a removable wheelbarrow liner for use in conjunction with a mixing apparatus in accordance with a preferred exemplary embodiment of the present invention;

FIG. 26 is a removable wheelbarrow liner positioned for use in a wheelbarrow for use in conjunction with a mixing apparatus in accordance with a preferred exemplary embodiment of the present invention; and

FIG. 27 is a clamping mechanism used to attach a mixing apparatus for mixing materials in a wheelbarrow in accordance with a preferred exemplary embodiment of the present invention.

### DETAILED DESCRIPTION

A portable mixing apparatus is adapted for mixing materials in a wheelbarrow or other container and is removably attached to a mixer support stand using at least one pivot point. The portable mixer includes a drive mechanism and a mixing body where the mixing body is repositionable in three dimensions, allowing for maximum flexibility in positioning the mixing body within the interior space of the wheelbarrow. Once the mixing body has been positioned, the mixing body is rotated by means of the drive mechanism affixed to the mixing body. The mixing body includes a plurality of mixing blades or paddles that will extend below the upper edge of the wheelbarrow frame and engage the materials to be mixed contained within the wheelbarrow. The drive mechanism may be a hand crank or motor. A removable liner is also included in certain embodiments.

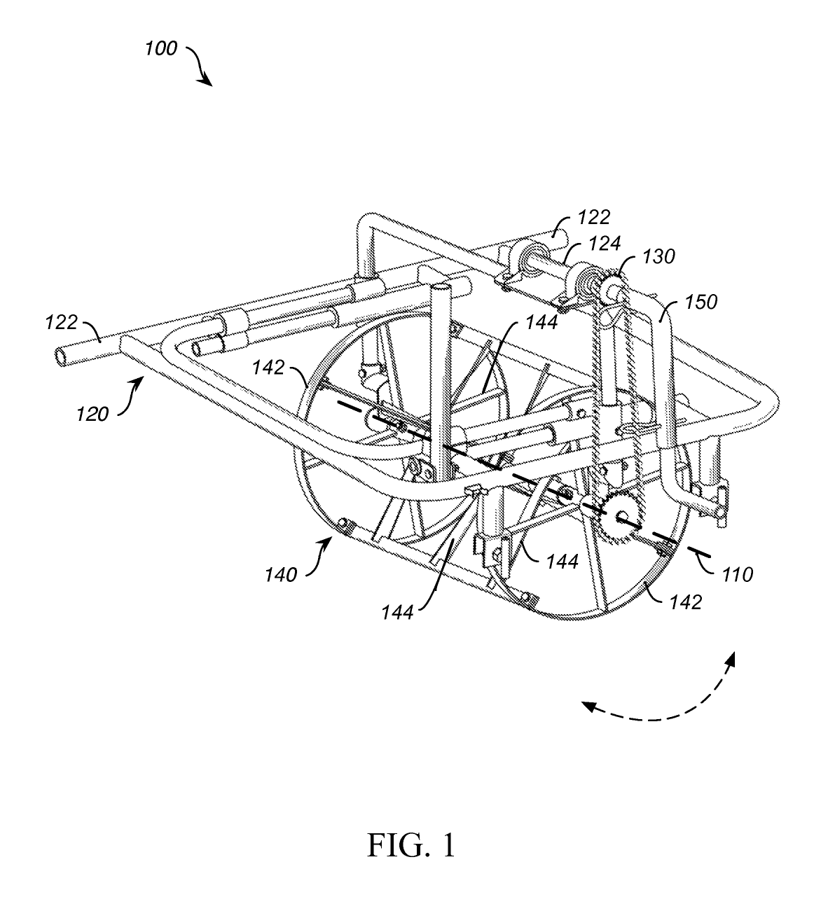

Referring now to FIG. 1, a perspective view of a mixing apparatus 100 in accordance with a preferred exemplary embodiment of the present invention is depicted. As shown in FIG. 1, the most preferred embodiments of mixing apparatus 100 comprises a support frame 120 manufactured from substantially circular pipe, including support points 122. A mixing body 140 comprises a pair of substantially hoop-shaped ends or body supports 142 and a plurality of mixing blades or paddles 144. Mixing vanes, blades or paddles 144 are used to engage a material within the interior space of a wheelbarrow and mix the material to the desired consistency. Additionally, a line 110 represents a substantially horizontal plane containing centerline of the shaft of mixing body 140.

Handle 150 is attached to shaft 124 and drive mechanism 130 (in this embodiment, a chain and sprocket drive system). Handle 150 can be grasped by an operator and turned in either direction and, depending on the rotational direction of handle 150, mixing body 140 rotates clockwise or counterclockwise around the central shaft of mixing body 140. Those skilled in the art will recognize that drive mechanism 130 could take many forms and use other types of mechanisms to rotate mixing body 140 (e.g., belts, pistons, etc.). Similarly, in at least some preferred embodiments of the present invention, handle 150 may be replaced by a motor or some other form of drive mechanism.

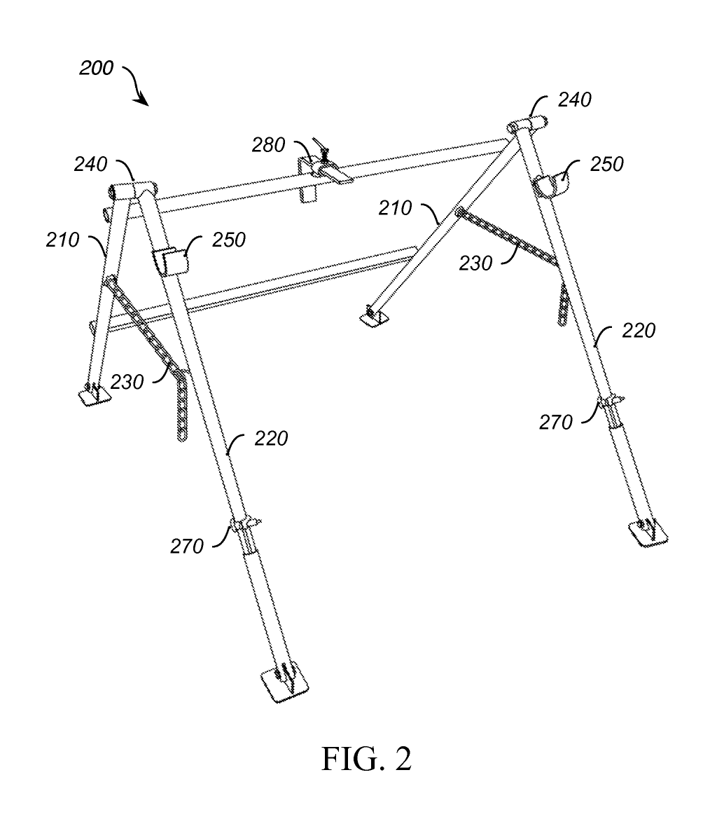

Referring now to FIG. 2, a support stand 200 for use in conjunction with mixing apparatus 100 of FIG. 1 in accordance with a preferred exemplary embodiment of the present invention is depicted. As shown in FIG. 2, support stand 200 comprises: a pair of non-adjustable back legs 210 and a pair of adjustable front legs 220; a pair of pivot supports 250, and a depth positioning mechanism 280. Back legs 210 and front legs 220 are connected by a pair of hinged joints 240 to form an “A-frame” structure that is capable of supporting mixing apparatus 100 and still allowing support stand 200 to be collapsed flat for storage and transportation when not in use. Additionally, each front leg 220 further comprises at least one height adjustment mechanism 270 that can be used to adjust the height of pivot supports 250 to accommodate various sizes of wheelbarrows or other mixing containers. A pair of chains 230 are used to adjust the distance between back legs 210 and front legs 220, providing for additional flexibility in the overall height of support stand 200.

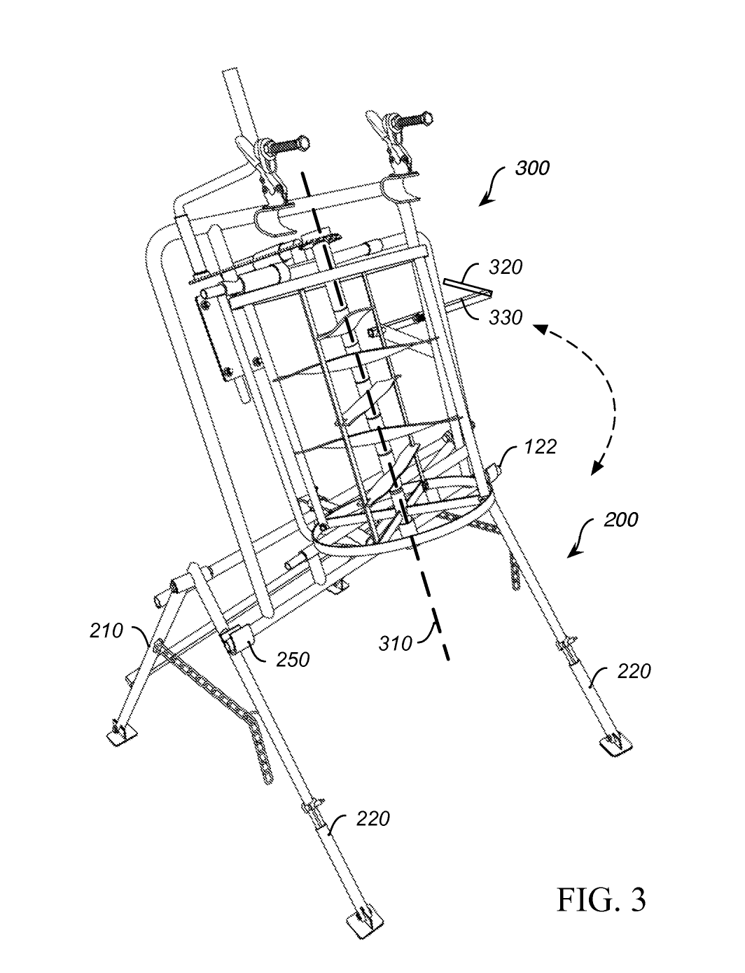

Referring now to FIG. 3, a mixing apparatus 300 has been placed in support stand 200 of FIG. 2. As shown in FIG. 3, support points 122 are resting in pivot supports 250, allowing mixing apparatus 300 to be raised to a substantially vertical position, with line 310 representing the centerline of the shaft of mixing apparatus 300. Mixing apparatus 300 will be raised to the vertical position to allow a wheelbarrow or other container to be placed below support stand 200, positioned between back legs 210 and front legs 220. Once the wheelbarrow is in place, mixing apparatus 300 may be rotated into a substantially horizontal orientation.

Additionally, it should be noted that a handle 320 is affixed to a lever arm 330. By manipulating handle 320, lever arm 330 will control the horizontal travel (e.g., back and forth motion) of the mixing body of mixing apparatus 300. This is especially useful during the mixing process since it will allow for a more uniform mixture to be obtained. As the mixing body engages the materials to be mixed, the rotational movement of the mixing body will naturally induce a horizontal travel into the mixing body handle 320 will allow the user to slow or stop the horizontal movement of the mixing body so as to achieve the most desirable mixing pattern.

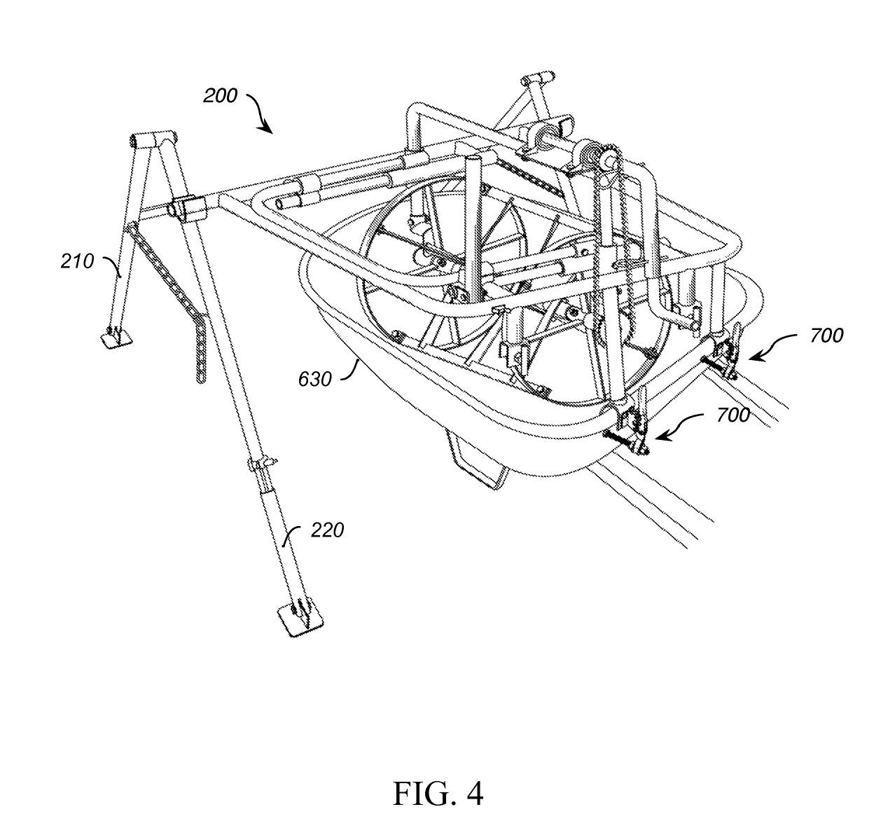

Referring now to FIG. 4, a wheelbarrow 630 has been positioned beneath support stand 200 and mixing apparatus 300 has been lowered into a second position (e.g., substantially but not exactly horizontal). A pair of locking mechanisms 700 have been engaged to secure wheelbarrow 630 in place.

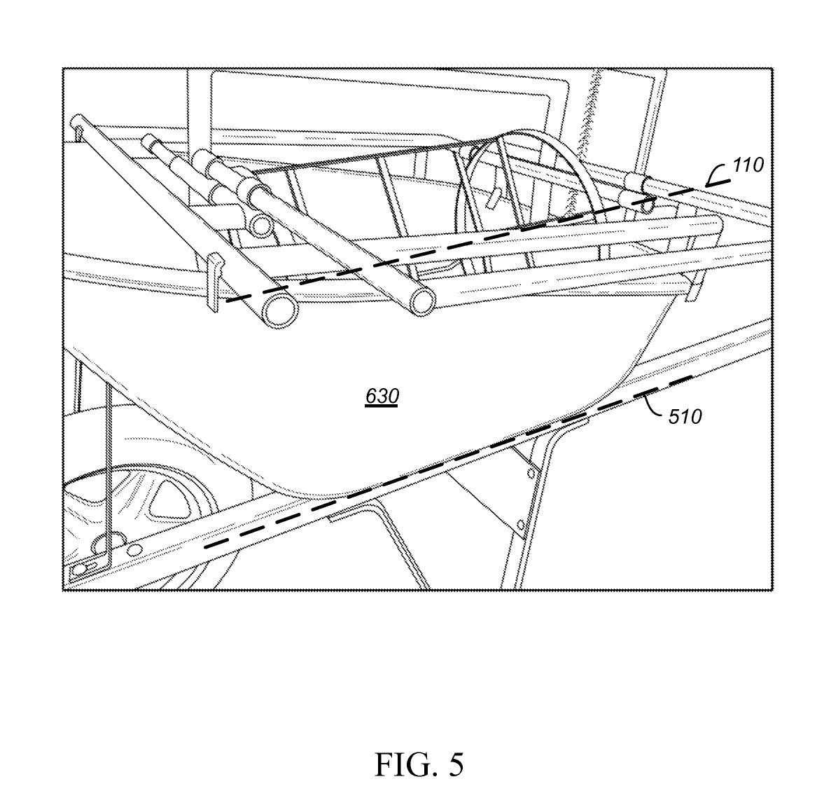

Referring now to FIG. 5, a pair of substantially parallel lines 110 and 510 represents a pair of substantially parallel planes. Line 110 represents the center shaft of mixing apparatus 300 and line 510 represents the planar surface defined by the bottom surface of wheelbarrow 630.

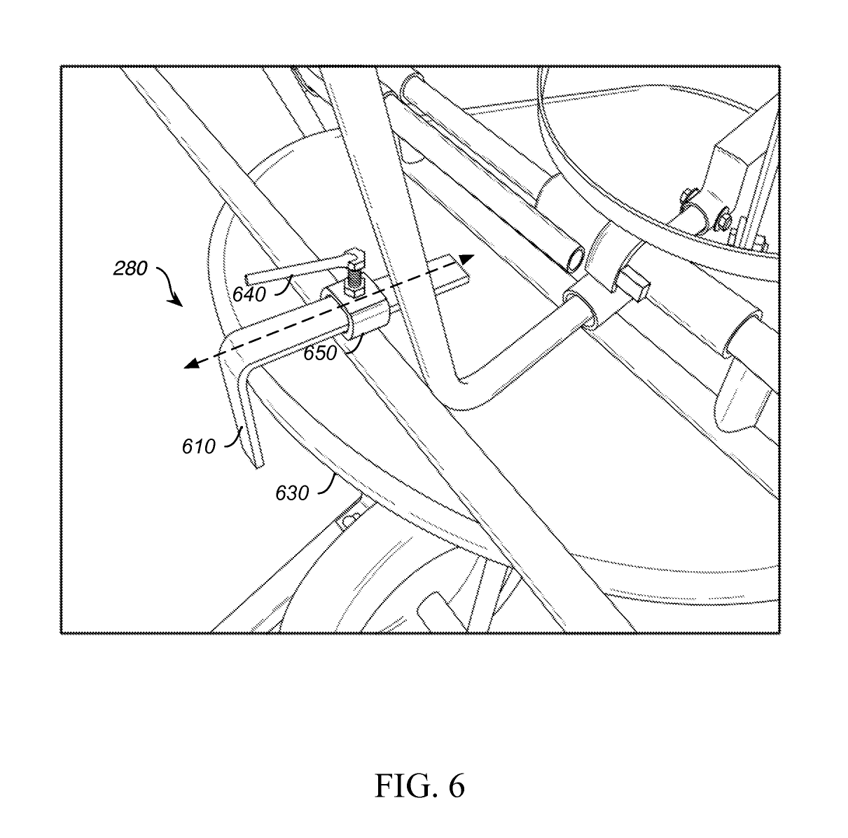

Referring now to FIG. 6, the nose of wheelbarrow 630 has been engaged by depth positioning mechanism 280. Depth positioning mechanism 280 comprises an “1-shaped” bracket 610 that is held in position by tubing 650 and turnbuckle 640. The relative length of bracket 610 can be adjusted forward or backward to accommodate various sizes of wheelbarrows 630.

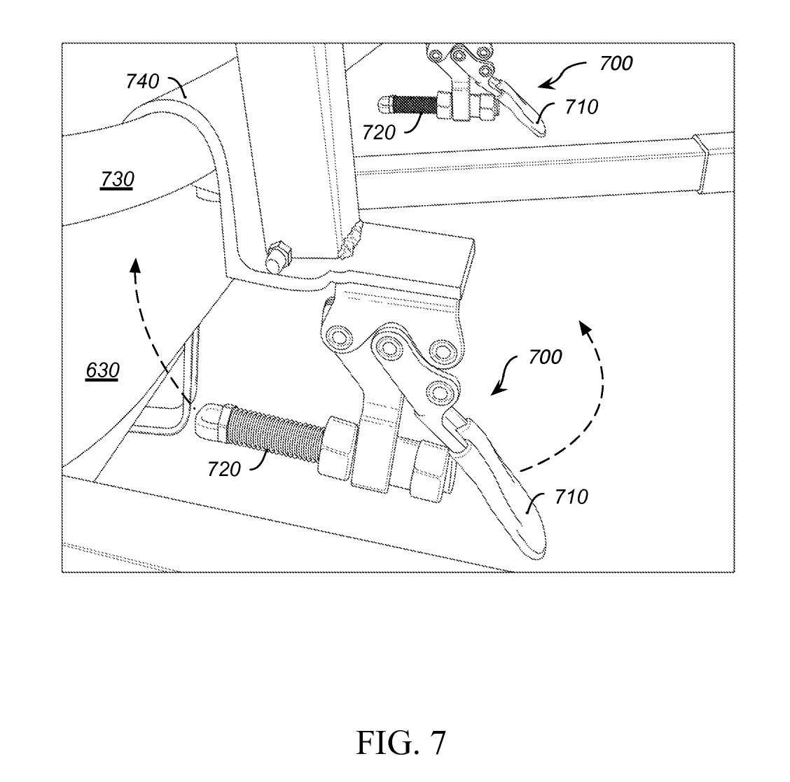

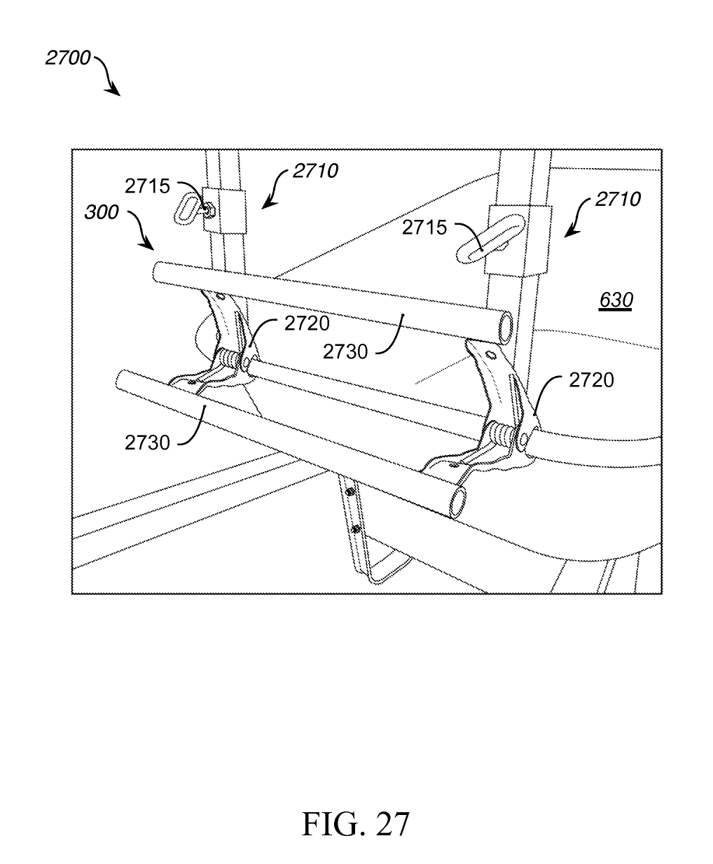

Referring now to FIG. 7, a pair of locking mechanisms 700 is illustrated. Locking mechanisms 700 are one embodiment of a mechanism used to selectively attach or connect mixing apparatus 300 to wheelbarrow 630. Locking mechanisms 700 can be manipulated into a “locked position” or an “unlocked position” by pressing or depressing lever arm handles 710. Lip 740 is an integral part of mixing apparatus 300 and lip 740 will rest on an upper edge 730 of wheelbarrow 630. By rotating lever arm handles 710 upward, threaded arms 720 are rotated into position and “locked” against upper edge 730 of wheelbarrow 630, thereby securing mixing apparatus 300 to wheelbarrow 630. FIG. 7 represents the “unlocked” position. An alternative method for attaching mixing apparatus 300 to wheelbarrow 630 is depicted in FIG. 27.

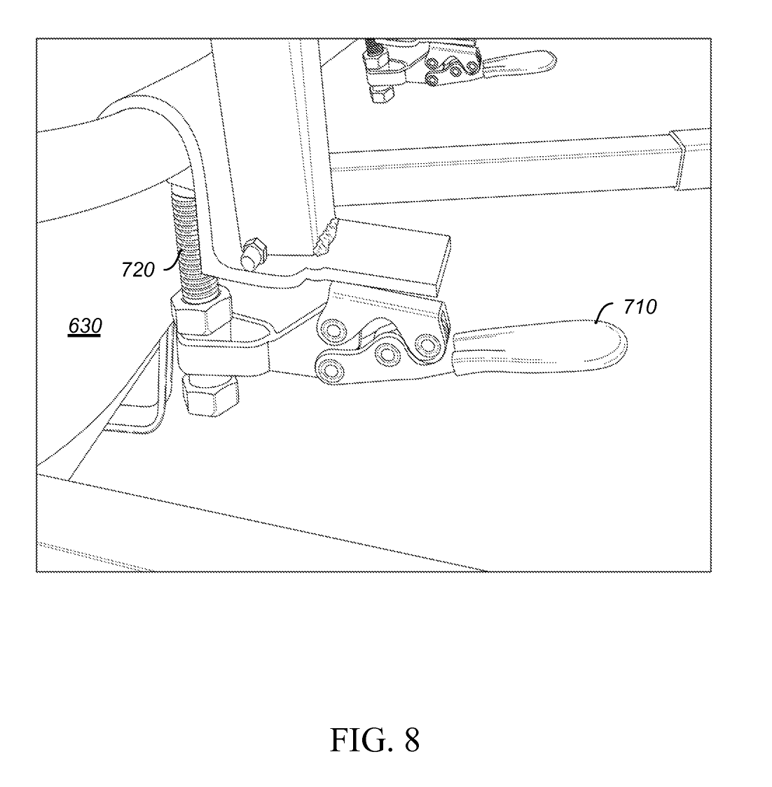

Referring now to FIG. 8, the “locked” position for locking mechanisms 700 of FIG. 7 is illustrated.

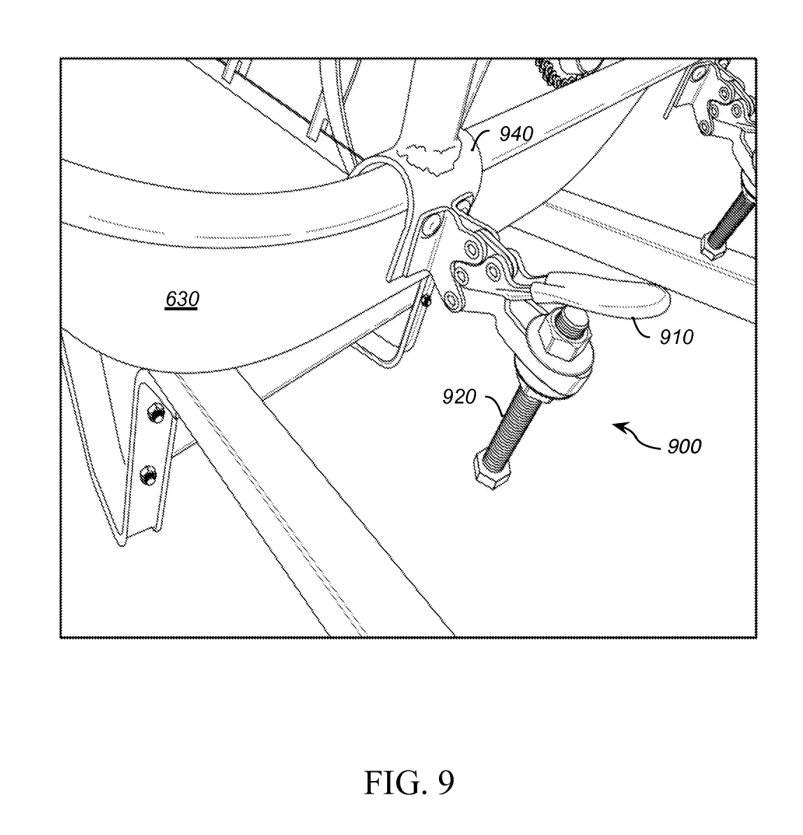

Referring now to FIG. 9, a pair of locking mechanisms 900 is illustrated. Locking mechanisms 900 are one embodiment of a mechanism used to selectively attach or connect mixing apparatus 300 to wheelbarrow 630. An alternative method for attaching mixing apparatus 300 to wheelbarrow 630 is depicted in FIG. 27. Similar to locking mechanisms 700 of FIG. 7 and FIG. 8, locking mechanisms 900 can be manipulated into a “locked position” or an “unlocked position” by pressing or depressing lever arm handles 910. By rotating lever arm handles 910 upward, threaded arms 920 are rotated into position and “locked” against the sidewall of wheelbarrow 630, thereby securing mixing apparatus 300 to wheelbarrow 630. FIG. 7 represents the “unlocked” position.

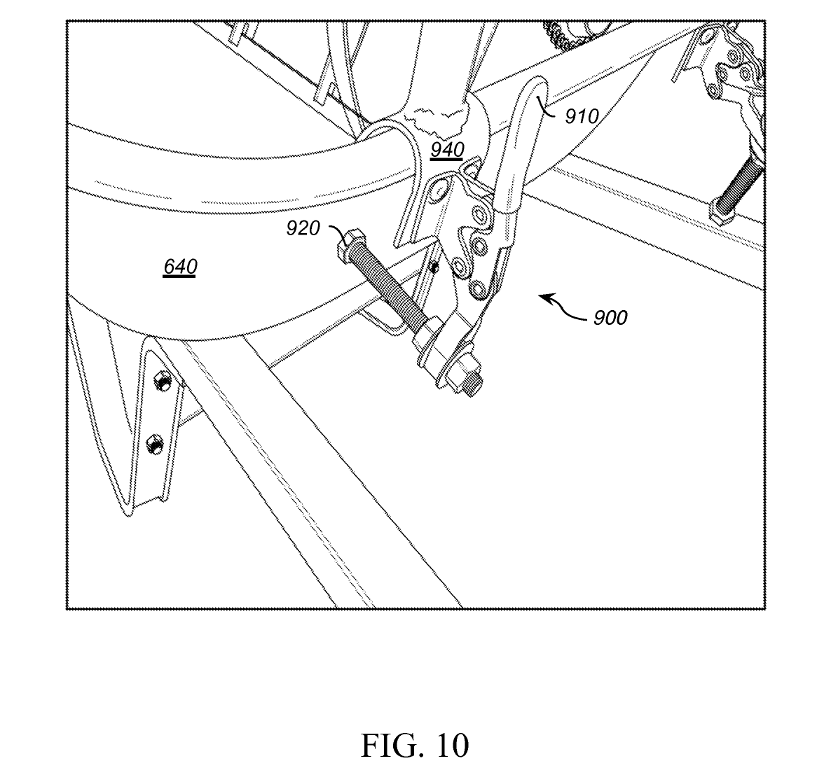

Referring now to FIG. 10, the “locked” position for a locking mechanism 900 of FIG. 9 is illustrated. It will be recognized by those skilled in the art that mixing apparatus 300 is attached to wheelbarrow 630 by a plurality of locking mechanisms (e.g., locking mechanisms 700 or locking mechanisms 900) and further secured by depth positioning mechanism 280 of FIG. 2. These various mechanisms provide a “3-point” or triangular securing mechanism. Further, since mixing apparatus 300 is resting on support stand 200, the legs of support stand 200 provide further support for wheelbarrow 630, thereby significantly enhancing the stability for the mixing process. This arrangement is significantly more supportive than previously known devices and methods.

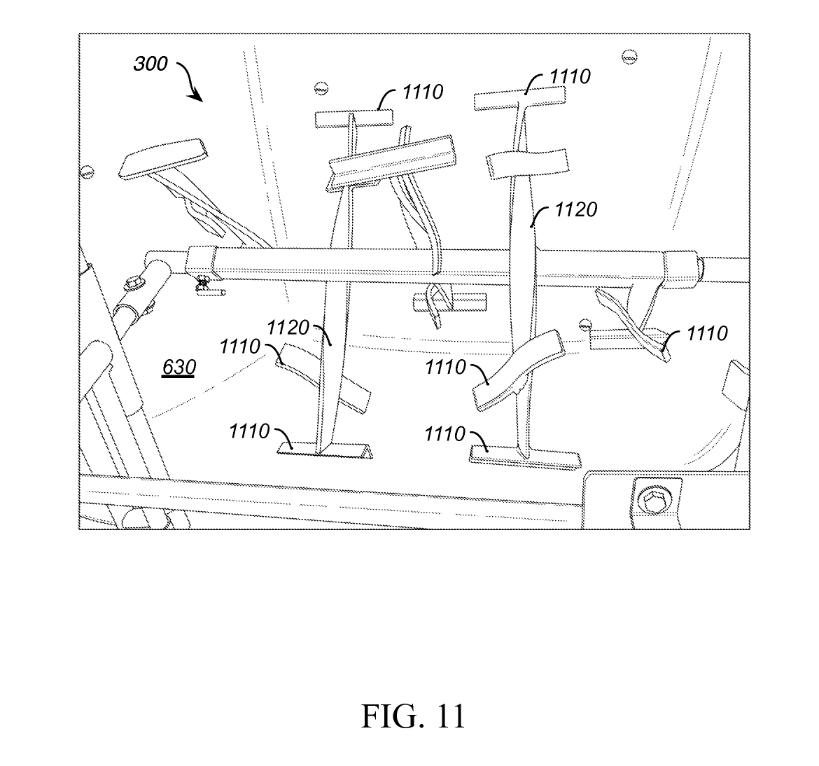

Referring now to FIG. 11, a plurality of mixing blades or mixing paddles 1110 are affixed to arms 1120. In the most preferred embodiments of the present invention, at least some of mixing blades or mixing paddles 1110 are substantially curvilinear or “s-shaped” mixing blades or mixing paddles 1110 and are coated with a non-stick substance.

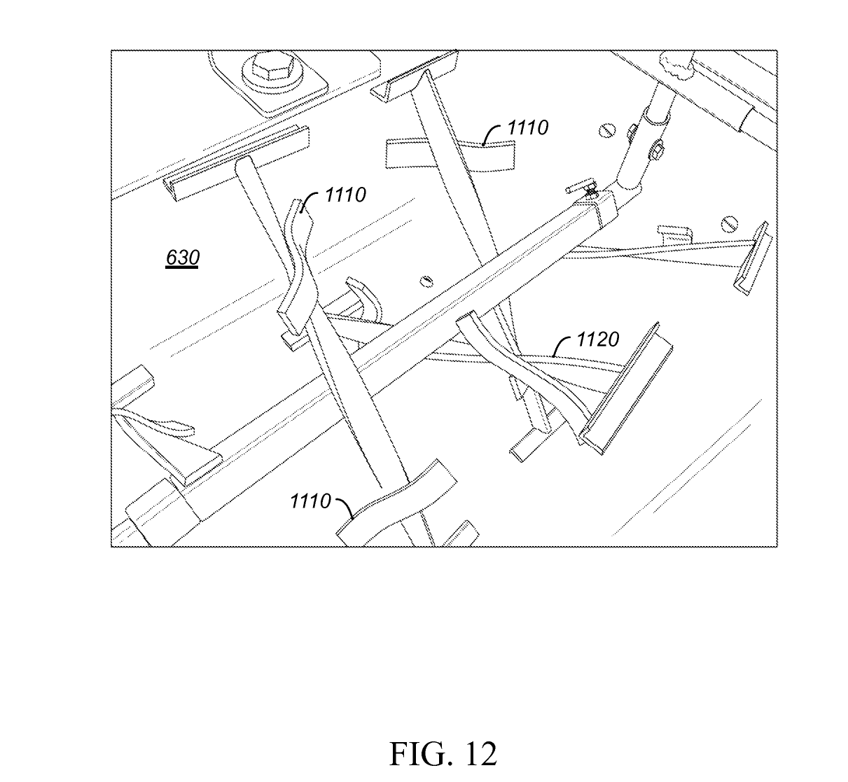

Referring now to FIG. 12, some mixing blades or mixing paddles 1110 are positioned so as to be substantially perpendicular to some other mixing blades or mixing paddles 1110, thereby providing for more efficient mixing of materials in wheelbarrow 630.

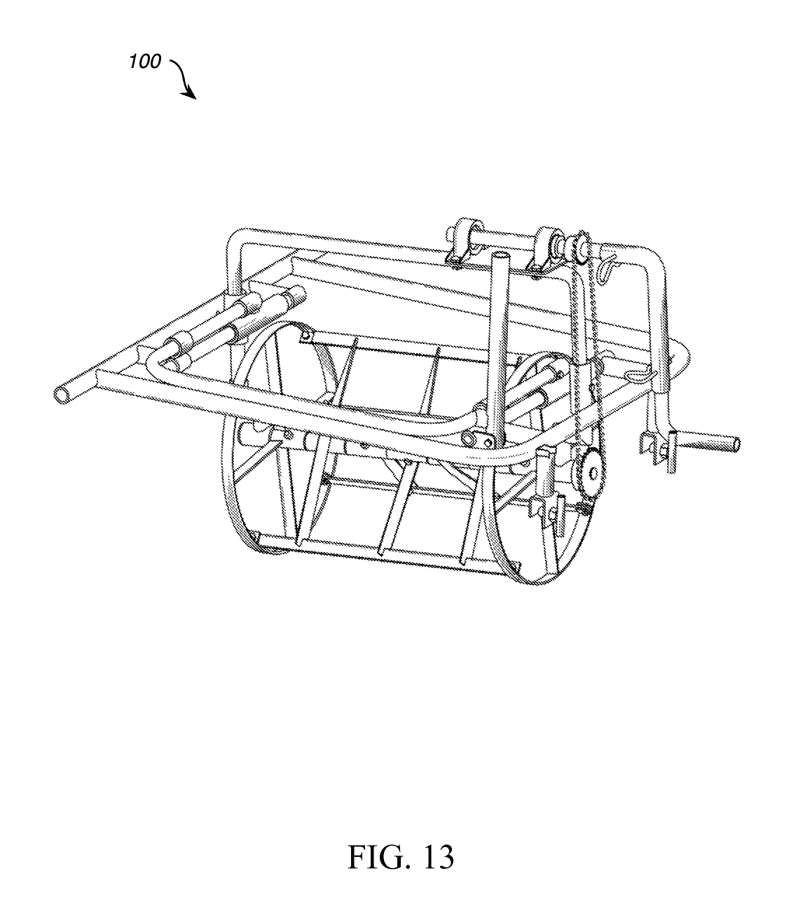

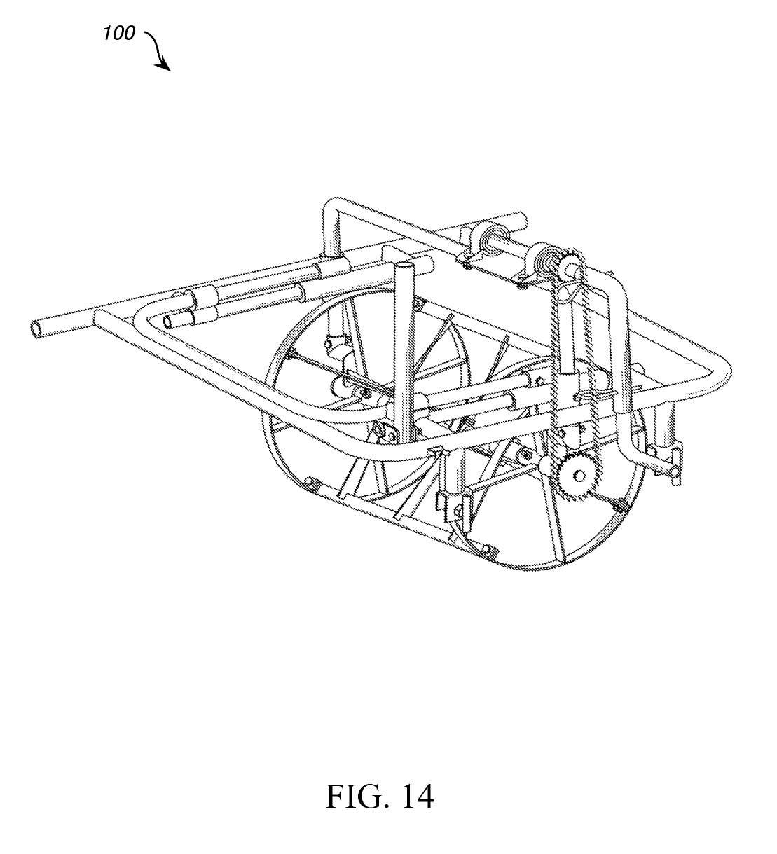

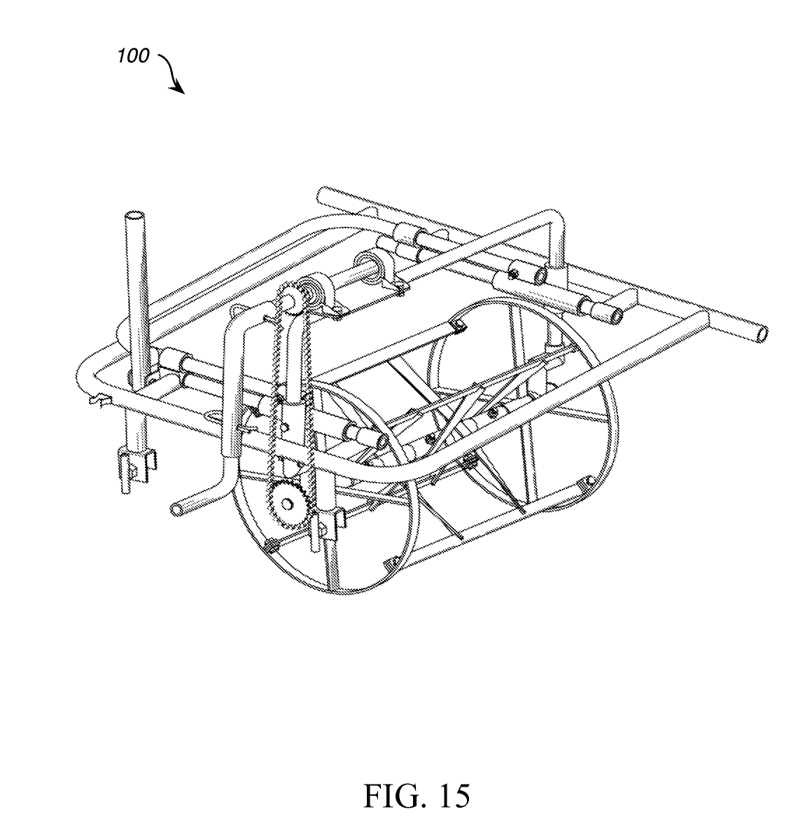

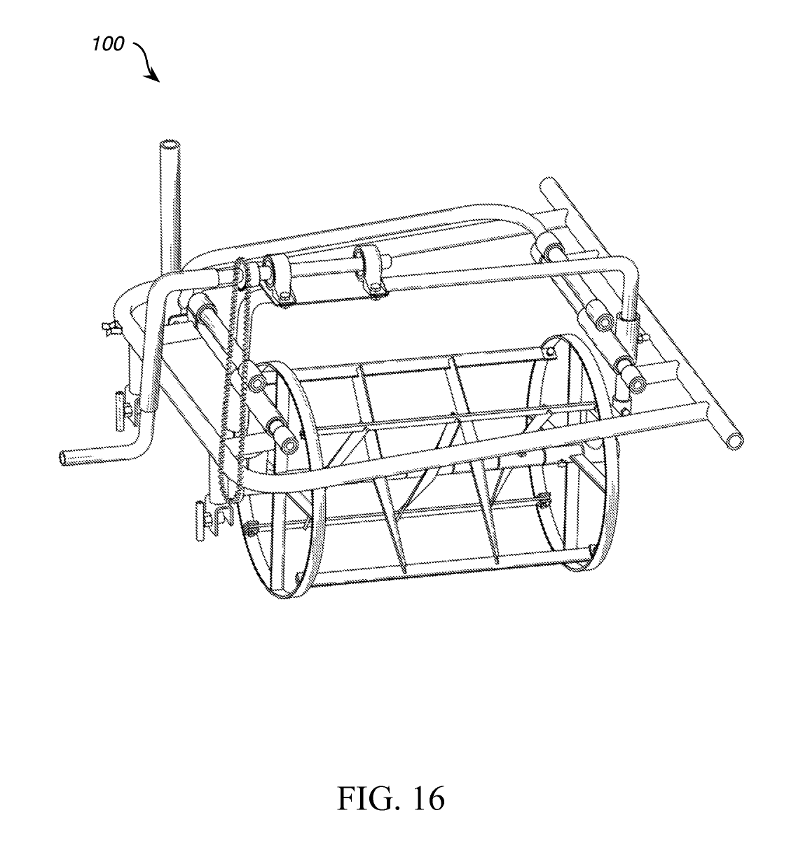

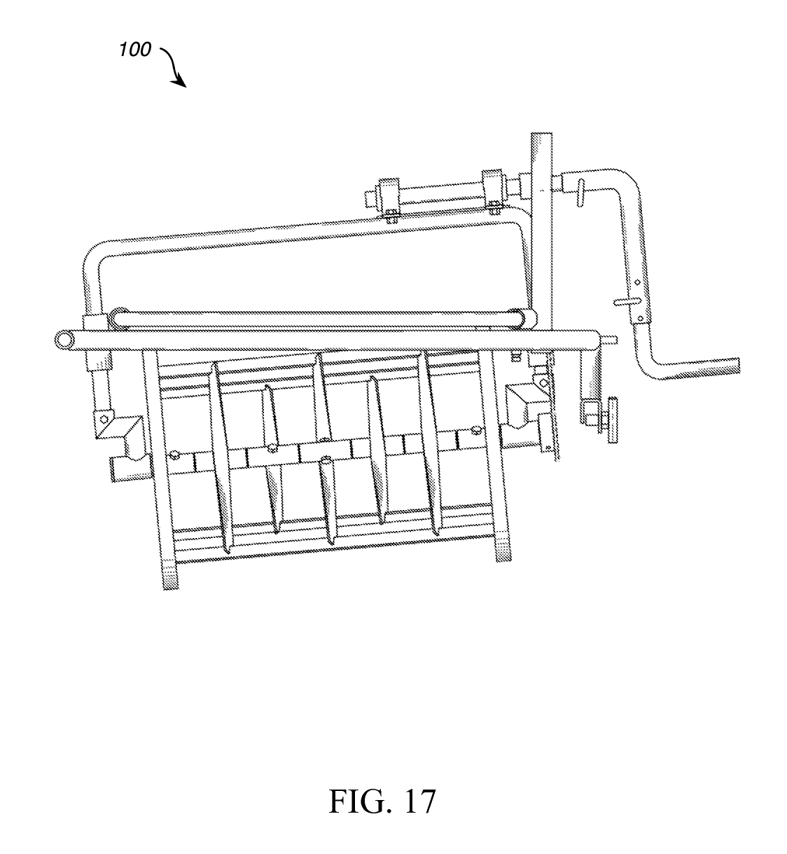

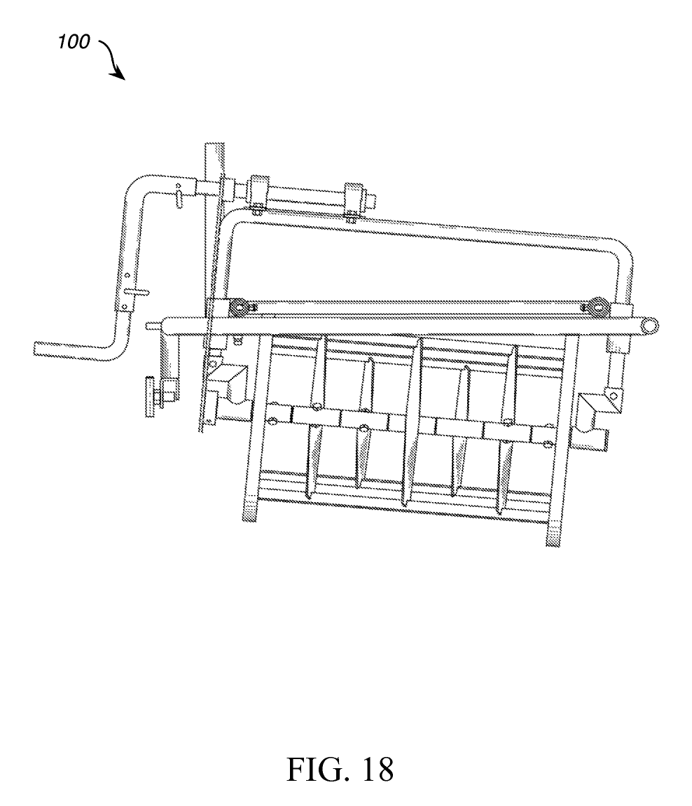

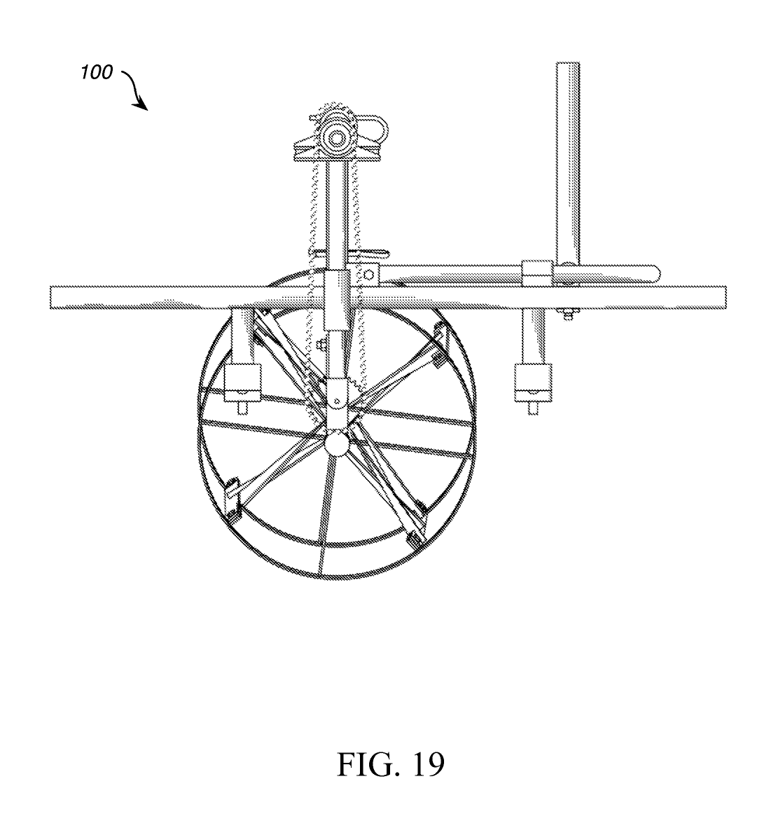

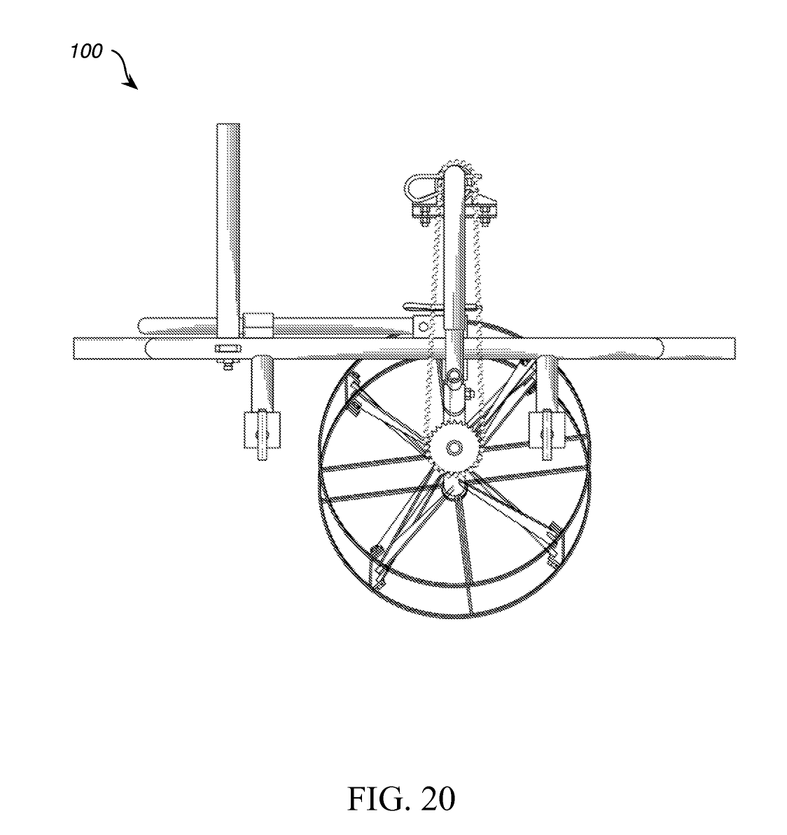

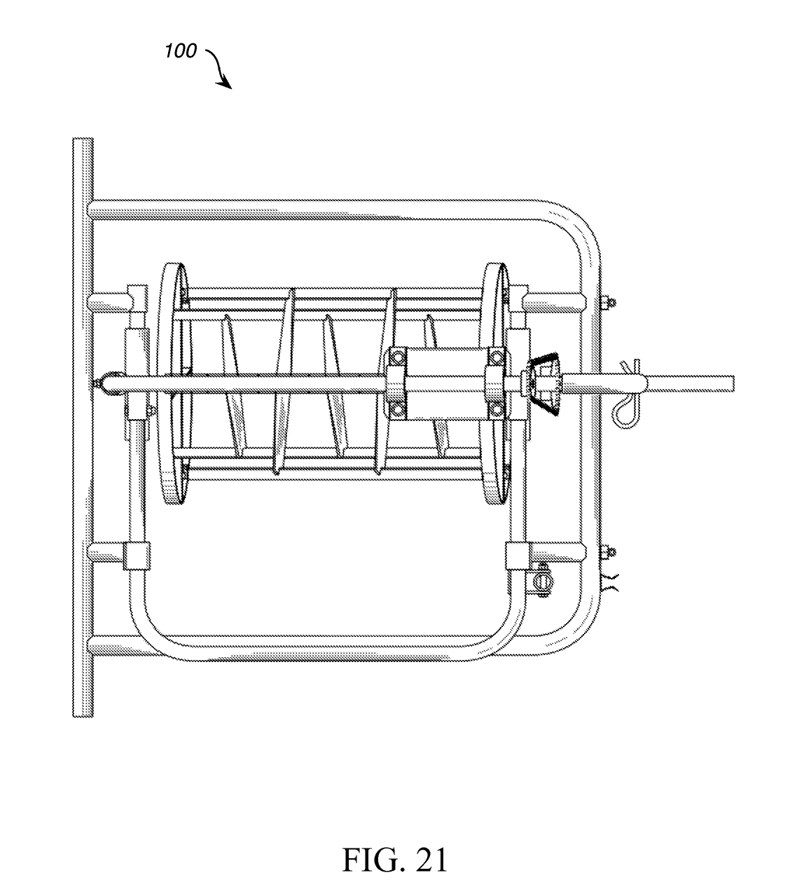

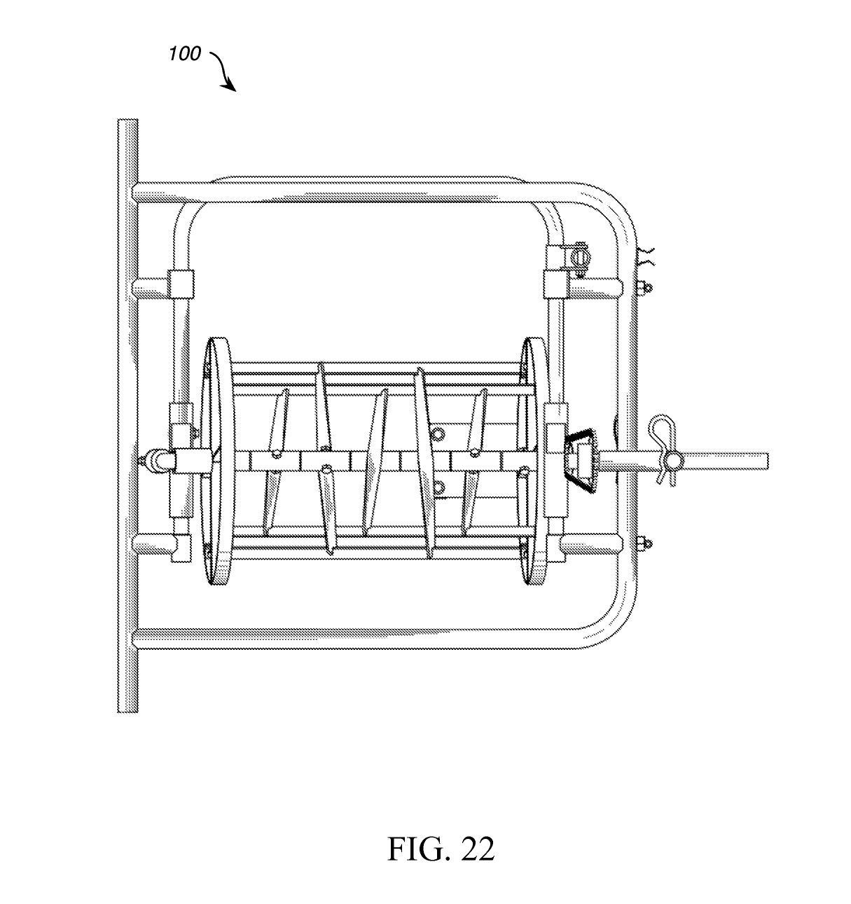

Referring now to FIG. 13-FIG. 22, various perspective views of certain embodiments of mixing apparatus 100 of FIG. 1 are illustrated.

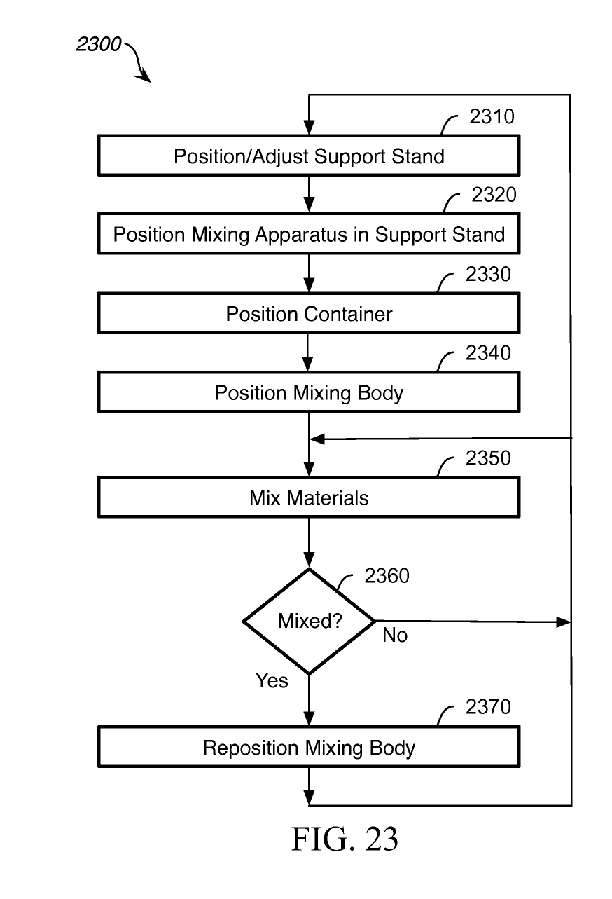

Referring now to FIG. 23, a method 2300 of mixing materials in a wheelbarrow in accordance with a preferred exemplary embodiment of the present invention is depicted. As shown in FIG. 23, the support stand will be positioned in the desired location (step 2310). Since the mixing apparatus of the present invention is lightweight and portable, the support stand can be positioned at the most convenient and efficient location at a job site. Once positioned and adjusted, the mixing apparatus can be removably and rotatably positioned on the support stand (step 2320) and rotated into a first position (e.g., a substantially vertical position), as shown in FIG. 3.

Next, the wheelbarrow or other container can be positioned beneath the support stand (step 2340) and the mixing apparatus can be rotated into a second position (e.g., a substantially horizontal position), as shown in FIG. 4 so as to engage the mixing blades or paddles of the mixing body in the materials contained in the container or wheelbarrow so that the materials can be mixed by the mixing body (step 2350). If necessary, the support stand may be further adjusted at this step of the process so as to achieve the optimal mixing results from the mixing process. As previously explained, the mixing process may be accomplished by turning a hand crank or by employing a motor, etc. Additionally, the materials to be mixed may be placed into the container or wheelbarrow at any stage of the process prior to the mixing step so the step of adding the materials to the container or wheelbarrow is not depicted. Additionally, as previously explained, the mixing body may be moved from side to side in the container or the wheelbarrow during the mixing process so as to further ensure the most optimal mixing process.

Periodically, the mixture can be inspected to determine whether or not the mixing process has combined or mixed the materials to the desired consistency (step 2360) and if the materials have not been properly mixed (step 2360=“NO”) then the mixing process can continue (step 2350) until the materials have been properly mixed (step 2360=“YES”). At that point in the process, the mixing apparatus can be rotated back into the first position (e.g., a substantially vertical position), as shown in FIG. 3, thereby repositioning the mixing body back to its original position and disengaging the mixing body from the materials contained in the container or wheelbarrow (step 2370).

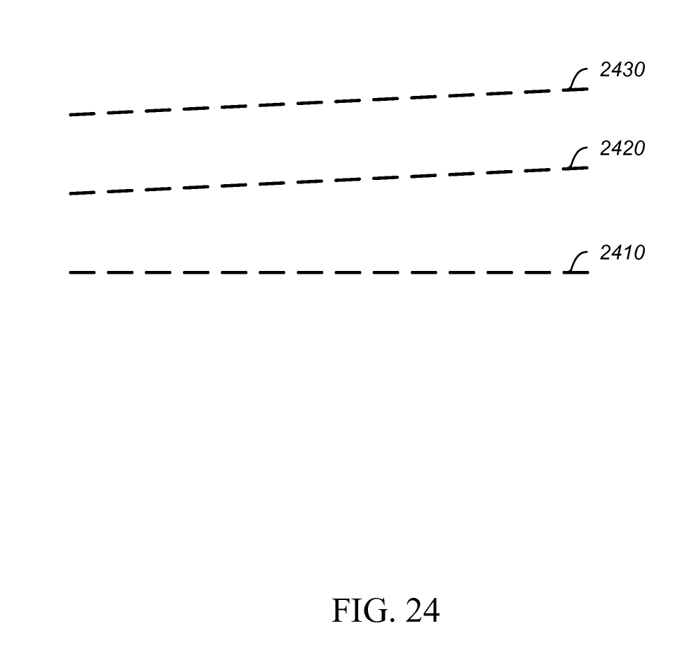

Referring now FIG. 24, a linear diagram represents the relationship between various components of the present invention. As shown in FIG. 24, line 2410 represents a plane that is defined by the surface of the ground. Line 2420 is a line that represents the plane defined by the bottom surface of the wheelbarrow body (e.g., line 510 of FIG. 5). Line 2430 is a line that represents a plane containing the centerline of the shaft of the mixing body of the mixing apparatus (e.g., centerline 110 of FIG. 1 and centerline 310 of FIG. 3). As can be seen in FIG. 24, line 2420 and line 2430 are substantially parallel with each other are not parallel with line 2410. This is an important consideration in the efficiency of the apparatus for mixing materials in a wheelbarrow inasmuch as the mixing blades or paddles are more likely to engage the materials to be mixed on a more consistent basis during the mixing process.

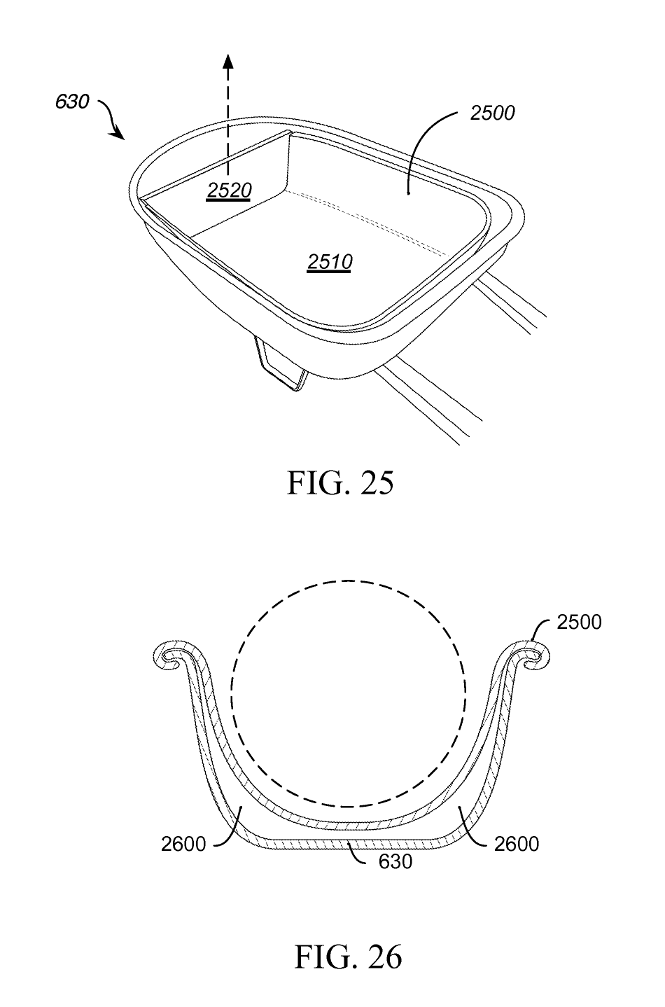

Referring now to FIG. 25, a removable wheelbarrow liner 2500 for use in conjunction with a mixing apparatus in accordance with a preferred exemplary embodiment of the present invention is depicted. Liner 2500 is most preferably a two-piece liner that can be inserted into and removed from the interior space of wheelbarrow 630. Liner 2500 most preferably comprises a body portion 2510 and an end portion 2520. The main function of liner 2500 is to alter the profile of the interior space for more efficient mixing. A secondary purpose of liner 2500 is to protect the interior surface of wheelbarrow 630.

Since some wheelbarrows have a somewhat rectangular shaped body, the circular nature of the mixing pattern created by mixing apparatus 300 may be less efficient when mixing thicker materials in wheelbarrow 630. This is due to the face that there may be a “dead space” where the sidewall of the wheelbarrow joins the bottom surface of the wheelbarrow that forms an approximate 80°-90° angle. This may make it difficult for the mixing blades to reach the materials in the “dead space.” By inserting liner 2500 into wheelbarrow 630, the contours of the mixing space containing the materials to be mixed is altered to more carefully match the rotational movement and position of the mixing body, the mixing arms, or the mixing paddles of mixing apparatus 300.

Additionally, removable end portion 2520 is positioned in wheelbarrow 630 and is substantially perpendicular to the ground. Removable end portion 2520 serves to further restrain or contain the material in the interior space of the wheelbarrow to a more compact space, providing for more efficient and thorough mixing, particularly with more viscous materials. Once the materials in wheelbarrow 630 have been properly mixed, end portion 2520 may be removed from liner 2500, allowing the user of wheelbarrow 630 to empty the contents of wheelbarrow 630 in a conventional manner (e.g., by lifting the handles of wheelbarrow 630 to dump the contents out). It is important to note that if liner 2500 simply mimicked or followed the interior surface contours of wheelbarrow 630, it would only serve to protect the interior surface of wheelbarrow 630 and would not constrain the materials to be mixed in any significant way. It should also be noted that if end portion 2520 were not removable, it would be difficult, if not impossible, to empty the contents of wheelbarrow 630 in the conventional manner (e.g., by lifting the handles of wheelbarrow 630 to dump the contents out).

Referring now to FIG. 26, a cross sectional view of a removable wheelbarrow liner 2500 is positioned for use in wheelbarrow 630 for use in conjunction with mixing apparatus 300. The edges of liner 2500 may be manufactured so as to simply rest inside wheelbarrow 630, or manufactured so as to rest on the upper edge or lip of wheelbarrow 630 or manufactured so as to curl under and “snap” onto the upper edge or lip of wheelbarrow 630. As shown in FIG. 26, a more circular profile is created when liner 2500 is positioned in wheelbarrow 630, thereby eliminating “dead spaces” 2600. This allows for more uniform and complete mixing of the materials placed into wheelbarrow 630 for mixing.

Referring now to FIG. 27, a clamping mechanism 2700 used to attach mixing apparatus 300 to wheelbarrow 630 in accordance with a preferred exemplary embodiment of the present invention is depicted. As shown in FIG. 27, clamping mechanism 2700 comprises a pair of clamp handles 2730 affixed to a pair of spring-loaded clamps 2720. By grasping clamp handles 2730 and squeezing them together, the operator of mixing apparatus 300 can selectively attach and detach spring-loaded clamps 2720 to the edge or lip of wheelbarrow 630. In this fashion, mixing apparatus 300 can be attached to or detached from wheelbarrow 630. In addition, a pair of vertical adjustment clamps 2710 are also included as part of mixing apparatus 300. Each vertical adjustment clamp 2710 comprises a sleeve component with a screw-fit handle 2715. After loosing screw-fit handle 2715, the vertical height of the mixing body of mixing apparatus 300 can be adjusted in the vertical direction to engage the materials contained within wheelbarrow 630 at the desired depth.

Prior mixing devices, particularly those that are not connected to the wheelbarrow, tend to have a mixing body where the central shaft of the mixing body is horizontal in a plane that is substantially parallel to the ground. Since the floor of the wheelbarrow is often not parallel to the ground, this will often leave at least a portion of the materials to be mixed in a relatively inaccessible position within the wheelbarrow, leading to sub-optimal mixing results.

From the foregoing description, it should be appreciated that an enhanced apparatus and method for mixing materials in a wheelbarrow is provided by the various preferred embodiments of the present invention and that the various preferred embodiments offer significant benefits that would be apparent to one skilled in the art. For example, although the detailed description of the invention describes the use of the apparatus in a construction environment, those skilled in the art will understand that additional preferred embodiments of the apparatus and methods described herein could be readily adapted for use in a wide variety of other applications such as preparing large quantities of on-site animal feed and the like.

The various preferred embodiments of the present invention further provide for positioning the mixing apparatus in the wheelbarrow in an almost infinite number of positions and angles, relative to the surface of the wheelbarrow. The height of the mixing apparatus can be adjusted. The left and right position of the mixing apparatus within the wheelbarrow can be adjusted. The forward and back position (depth) of the mixing apparatus within the wheelbarrow can be adjusted. These adjustments provide for positioning the mixing apparatus in 3-space in the best position to achieve the most effective and efficient mixing of materials, based on the viscosity of the materials, aggregate used, etc. The use of a two-piece removable liner is also advantageous to eliminate “dead spaces” where efficient and effective mixing is less likely to occur.

Furthermore, while multiple preferred embodiments have been presented in the foregoing description, it should be appreciated that a vast number of variations in the preferred embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. An apparatus comprising:
an adjustable support stand, the adjustable support stand comprising a plurality of adjustment mechanisms;
a mixing device removably attached to the adjustable support stand, the mixing device comprising:
a repositionable mixing body, the mixing body comprising:
a plurality of mixing arms; and
an attachment mechanism, the attachment mechanism being configured to removably attach the mixing body to a wheelbarrow frame; and
a drive mechanism, the drive mechanism being configured to rotate the mixing body within an interior space defined by the wheelbarrow frame, thereby engaging a material to be mixed, the material to be mixed being contained within the interior space of the wheelbarrow.

2. The apparatus of claim 1 wherein the mixing body comprises:
a plurality of mixing arms; and
a plurality of mixing blades affixed to the plurality of mixing arms, wherein the plurality of mixing blades comprises a plurality of substantially curvilinear mixing blades and wherein at least a portion of the plurality of mixing blades are positioned so as to be substantially perpendicular to at least another portion of the plurality of mixing blades.

3. The apparatus of claim 1 wherein the mixing body comprises:
a substantially hoop-shaped first end;
a substantially hoop-shaped second end;
a plurality of connecting members extending between and being attached to the first end and the second end; and
a plurality of mixing vanes affixed to the plurality of connecting members wherein the plurality of mixing arms are attached to the plurality of mixing vanes.

4. The apparatus of claim 1 wherein the plurality of adjustment mechanisms comprises:
a pair of fixed length legs and a pair of adjustable length legs affixed to the adjustable support stand, the pair of adjustable length legs providing a vertical height adjustment mechanism for the mixing device;
an adjustable retaining guide, the adjustable retaining guide providing a horizontal adjustment mechanism for positioning the mixing body relative to the wheelbarrow frame; and
a lever arm, the lever arm being affixed to the mixing body and configured to move the mixing body in a horizontal direction within the interior space of the wheelbarrow frame.

5. The apparatus of claim 1 wherein the attachment mechanism comprises a pair of spring-loaded clamps affixed to the mixing body.

6. The apparatus of claim 1 wherein the attachment mechanism comprises a pair of locking mechanisms, each of the locking mechanisms having an unlocked position and a locked position.

7. The apparatus of claim 1 further comprising a two-piece liner placed into the interior space defined by the wheelbarrow frame and being configured to confine a material placed into the two-piece liner, the two-piece liner comprising:
a repositionable body portion; and
a removable end portion, the removable end portion comprising a substantially vertical member.

8. The apparatus of claim 1 wherein a centerline of the drive mechanism lies in a first plane and a bottom portion of the wheelbarrow frame lies in a second plane.

9. The apparatus of claim 1 wherein the drive mechanism comprises:
a chain; and
a sprocket.

10. The apparatus of claim 1 wherein the drive mechanism comprises a motor affixed to the mixing body.

11. An apparatus for mixing materials in a wheelbarrow comprising:
an adjustable support stand, the adjustable support stand comprising a plurality of adjustment mechanisms, the plurality of adjustment mechanisms comprising:
a pair of fixed length legs and a pair of adjustable length legs affixed to the adjustable support stand, the pair of adjustable length legs providing a vertical height adjustment mechanism for the mixing device;
an adjustable retaining guide, the adjustable retaining guide providing a horizontal adjustment mechanism for positioning the mixing body relative to a wheelbarrow frame; and
a lever arm, the lever arm being affixed to the mixing body and configured to move the mixing body in a horizontal direction within the interior space of the wheelbarrow frame;
a drive mechanism comprising:
a chain; and
a sprocket;
a mixing device removably attached to the adjustable support stand, the mixing device comprising:
a repositionable mixing body, the mixing body comprising:
a plurality of mixing arms; and
a plurality of adjustment mechanisms;
a two-piece liner placed into the interior space defined by the wheelbarrow frame and being configured to confine a material placed into the two-piece liner, the two-piece liner comprising:
a repositionable body portion; and
a removable end portion, the removable end portion comprising a substantially vertical member;
a drive mechanism, the drive mechanism being configured to rotate the mixing body within an interior space defined by the wheelbarrow frame, thereby engaging a material to be mixed, the material to be mixed being contained within the interior space of the wheelbarrow; and
a pair of vertical adjustment clamps, the vertical adjustment clamps being configured to adjust a vertical position of the mixing body.

12. A method comprising the steps of:
removably attaching a mixing apparatus to an adjustable support stand, wherein the adjustable support stand comprises a plurality of adjustment mechanisms and wherein the mixing apparatus comprises:
a repositionable mixing body, the mixing body comprising:
a plurality of mixing arms; and
an attachment mechanism, the attachment mechanism being configured to removably attach the mixing body to a wheelbarrow frame of a wheelbarrow; and
a drive mechanism, the drive mechanism being configured to rotate the mixing body within an interior space defined by the wheelbarrow frame, thereby engaging a material to be mixed, the material to be mixed being contained within the interior space of the wheelbarrow.
adjusting a position of the mixing apparatus relative to the wheelbarrow by engaging a depth positioning mechanism;
adjusting a vertical position of the mixing body to optimize a mixing operation; and
adjusting a horizontal position of the mixing body to optimize a mixing operation.

13. The method of claim 12 wherein the mixing body comprises:
a plurality of mixing arms; and
a plurality of mixing blades affixed to the plurality of mixing arms, wherein the plurality of mixing blades comprises a plurality of substantially curvilinear mixing blades and wherein at least a portion of the plurality of mixing blades are positioned so as to be substantially perpendicular to at least another portion of the plurality of mixing blades.

14. The method of claim 12 wherein the mixing body comprises:
a substantially hoop-shaped first end;
a substantially hoop-shaped second end;
a plurality of connecting members extending between and being attached to the first end and the second end; and
a plurality of mixing vanes affixed to the plurality of connecting members wherein the plurality of mixing arms are attached to the plurality of mixing vanes.

15. The method of claim 12 wherein the attachment mechanism comprises a pair of spring-loaded clamps affixed to the mixing body.

16. The method of claim 12 wherein the attachment mechanism comprises a pair of locking mechanisms, each of the locking mechanisms having an unlocked position and a locked position.

17. The method of claim 12 wherein the plurality of adjustment mechanisms comprises:
a pair of fixed length legs and a pair of adjustable length legs affixed to the adjustable support stand, the pair of adjustable length legs providing a vertical height adjustment mechanism for the mixing device;
an adjustable retaining guide, the adjustable retaining guide providing a horizontal adjustment mechanism for positioning the mixing body relative to the wheelbarrow frame; and
a lever arm, the lever arm being affixed to the mixing body and configured to move the mixing body in a horizontal direction within the interior space of the wheelbarrow frame.

18. The method of claim 12 further comprising the step of placing a two-piece liner into the interior space defined by the wheelbarrow frame, the two-piece liner comprising:
a repositionable body portion; and
a removable end portion, the removable end portion comprising a substantially vertical member.

19. The method of claim 12 wherein a centerline of the drive mechanism lies in a first plane and a bottom portion of the wheelbarrow frame lies in a second plane.

20. The method of claim 12 wherein the drive mechanism comprises one of a chain and sprocket combination and a motor.
